(19) United States
(12) Patent Application Publication
(10) Pub. No.: US 2026/0084218 A1
(43) Pub. Date: Mar. 26, 2026

(54) FLOWABILITY OF AM POWDERS

(71) Applicant: PRATT & WHITNEY CANADA CORP., Longueuil (CA)

(72) Inventors: Jean-Rene Poulin, Saint-Hubert (CA); Francois Richard, St-Denis-Sur-Richelieu (CA)

(21) Appl. No.: 18/897,978

(22) Filed: Sep. 26, 2024

(51) Int. Cl. B22F 12/60; B22F 10/28; B22F 12/30; B29C 64/153; B29C 64/205; B29C 64/245; B33Y 10/00; B33Y 30/00

(52) U.S. Cl. CPC B22F 12/60; B22F 10/28; B22F 12/30; B29C 64/153; B29C 64/205; B29C 64/245; B33Y 10/00; B33Y 30/00

(57) ABSTRACT

A powder bed fusion additive manufacturing system includes a build powder bed positioned on a build plate in a build chamber, an energy source scanning system configured to scan an energy source across a top layer of the build powder bed to consolidate selected portions of the top layer to build a single layer of a desired part, a build piston configured to adjust the height of the build plate after the layer of the desired part is built, and a fresh build powder distributor configured to distribute a layer fresh build powder over a build powder bed such that the layer of fresh build powder is level and smooth. The fresh build powder distributor comprises a distributor excitation device configured to cause the fresh build powder distributor to vibrate at a predetermined vibrational frequency while distributing the layer of fresh build powder over the build powder bed.

### BACKGROUND

The present disclosure relates generally to powder bed fusion additive manufacturing (AM) techniques and, more particularly, to an approach to disturbing build powder in a powder bed fusion additive machine.

One of limiting factors to the productivity of additive manufacturing equipment constructed with a powder-bed based architecture is the time required to spread the powder feedstock to a thin and uniform layer. This is generally done with a mechanical device (a recoater) that travels across the whole build surface to deposit the powder feedstock evenly. The powder bed uniformity (e.g. thickness and density) is a critical variable of the process to ensure stable melting and defect-free consolidation of the powder.

The speed at which the powder layer can be spread to form a uniform thin layer is limited by the flowability of the powder feedstock, which is a characteristic related to the powder particles size distribution, shape distribution (e.g. sphericity), surface characteristics, density, etc.

### SUMMARY

One aspect of this disclosure is directed to a powder bed fusion (PBF) additive manufacturing (AM) system that includes a build powder bed positioned on a build plate in a build chamber, an energy source scanning system configured to scan an energy source across a top layer of the build powder bed to consolidate selected portions of the top layer to build a single layer of a desired part, a build piston configured to adjust the height of the build plate and the build powder bed after the layer of the desired part is built, and a fresh build powder distributor configured to distribute a layer fresh build powder over a build powder bed such that the layer of fresh build powder is level and smooth. The fresh build powder distributor comprises a distributor excitation device configured to cause the fresh build powder distributor to vibrate at a predetermined vibrational frequency while distributing the layer of fresh build powder over the build powder bed.

Another aspect of the disclosure is directed to a method of making a part on a PBF AM system that includes scanning, with an energy source scanning system, an energy source across a top layer of the build powder bed to consolidate selected portions of the top layer to build a single layer of a desired part; adjusting, with a build piston, the height of the build plate and the build powder bed after the layer of the desired part is built; distributing, with a fresh build powder distributor, a layer fresh build powder over a build powder bed such that the layer of fresh build powder is level and smooth; and vibrating, with a distributor excitation device, the fresh build powder distributor to vibrate at a predetermined vibrational frequency while distributing the layer of fresh build powder over the build powder bed.

### BRIEF DESCRIPTION OF THE DRAWINGS

FIG. 1 is a schematic view of a prior art powder bed fusion (PBF) additive manufacturing (AM) system.

FIG. 2 is a schematic view of a PBF AM system of the present disclosure.

FIG. 3 is a schematic view of another PBF AM system of the present disclosure.

FIG. 4 is a schematic view of yet another PBF AM system of the present disclosure

### DETAILED DESCRIPTION

A wide variety of parts including parts for gas turbine engines can be made using additive manufacturing (AM) methods, including powder bed fusion (PBF) AM techniques. PBF AM is an additive manufacturing, or 3-D printing, technology that uses an energy source, such as a laser (PBF-LB) or electron beam (PBF-EB), to sinter or fuse metallic or polymeric particles together in a layer-by-layer process. PBF is typically used as an industrial process to make near net shape parts with various geometries.

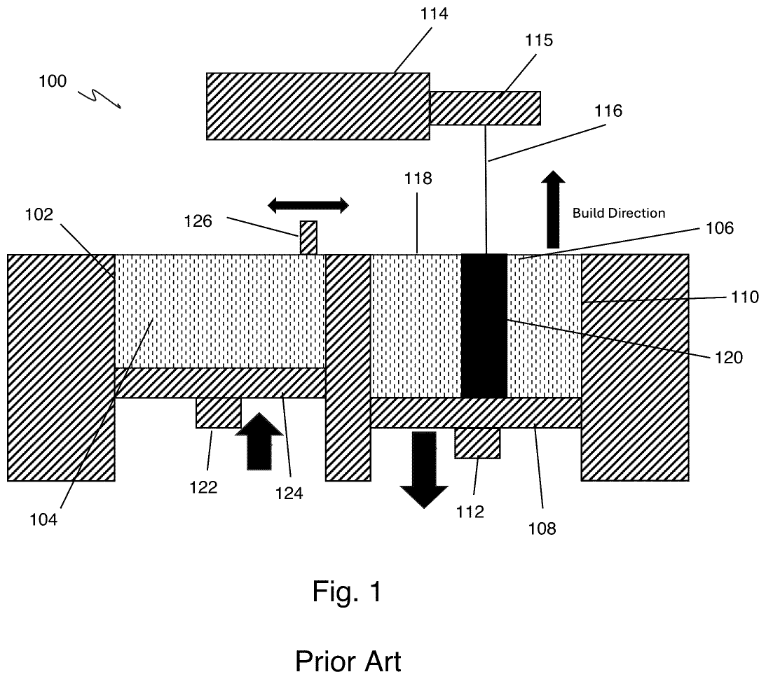

PBF AM techniques are typically implemented on a PBF AM system such as the system 100 depicted in FIG. 1. The PBF AM system 100 includes a build powder reservoir 102 that includes fresh build powder 104 that is available for use during a PBF AM build campaign. The build powder bed 106 that is in active use during a PBF AM build campaign is positioned on a build plate 108 that is configured to operate in a build chamber 110 based on movement of a build piston 112. After an initial charge of build powder bed 106 from the build powder reservoir 102 is placed onto the build plate 108 in the build chamber 110, an energy source 114 with scanning system 115 scans an energy source 116 over a top layer 118 of the build powder bed 106. As discussed above, the energy source 116 can be a laser (for a PBF-LB process) or an electron beam (for a PBF-EB process). The energy source 116 fuses, sinters, or consolidates selected portions of the top layer 118 as it scans across the top layer 118. As known in the art, the energy source scanning system 115 can be programmed to deliver a predetermined energy/power input with a predetermined scan pattern, scan rate, and energy source 116 power level to build a single layer of a desired part 120.

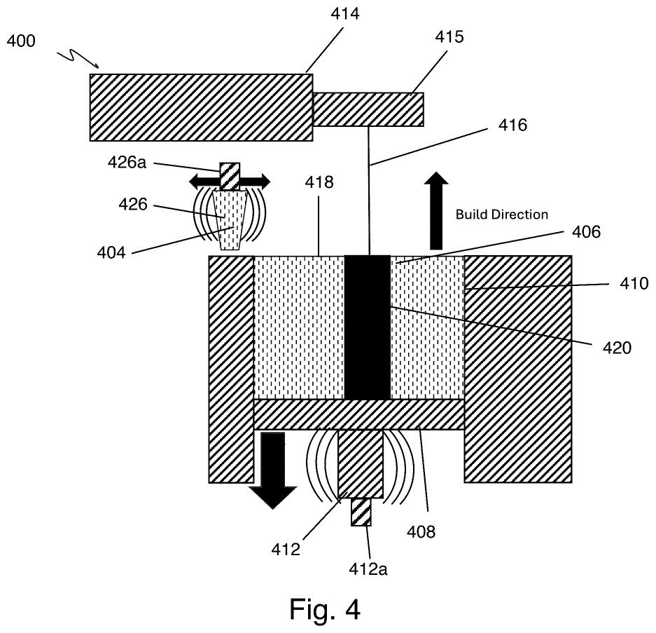

After the single layer of the desired part 120 is built, the build plate 108 is lowered, and a fresh powder distributor 126 is used to spread another layer of fresh powder feedstock 104 from build powder reservoir 102 on top of the build powder bed 106. The fresh build powder distributor can be any device configured to distribute a layer of fresh build powder 104 on top of the build powder bed 106 such that the layer of fresh build powder 104 is level and smooth. Examples of suitable fresh build powder distributors include the recoaters 126, 126′, and 126′″ of FIGS. 1-3 and the fresh build powder distributor 426 of FIG. 4. A person of ordinary skill will recognize that other devices suitable for distributing a layer of fresh build powder 104 on top of the build powder bed 106 are available.

In the example of FIG. 1, the build piston 112 lowers the build plate 108 in the build chamber 110 to create space to spread a layer of fresh build powder 104 on top of the build powder bed 106. In the example depicted in FIG. 1, a build powder piston 122 in the build powder reservoir raises a build powder plate 124 to raise a quantity of fresh build powder 104 that a recoater 126 spreads on top of the build powder bed 106. The recoater 126 typically travels across (traverses) the entire surface of the build chamber 110 to provide an even layer of fresh build powder 104 on top of the build powder bed 106. Following distribution of fresh build powder 104 on top of the build powder bed 106, the energy source scanning system 115 scans the top layer of the build powder bed 106 to form the next layer of the part 120. This process is repeated until the entire part 120 is built.

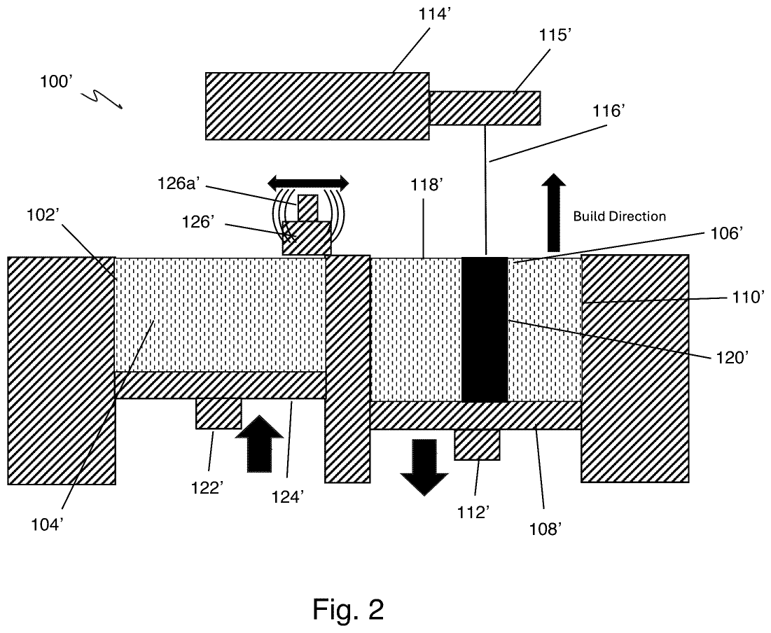

The speed at which the fresh build powder 104 can be spread with the recoater 126 to form a uniform thin layer of build powder bed 106 is limited by the flowability of the fresh build powder 104, which is a characteristic related to the powder particles size distribution, shape distribution (e.g. sphericity), surface characteristics, density, etc. As shown in FIG. 2, the flowability of the fresh build powder 104′ can be improved by vibrating the recoater 126′ at a predetermined frequency. The predetermined frequency can be any frequency suitable to cause the fresh build powder 104′ to pack into a more compacted, denser build powder bed 106′ as the recoater 126′ distributes fresh build powder 104′ over the build chamber 110′. Vibration can reduce friction between powder particles and the substrate (build plate 108 or part 120) and promote spread-ability. Vibration can also reduce friction forces between the powder particles themselves allowing the powder particles to flow more freely. For example, the predetermined frequency can be between 10 Hz to 70 kHz. The recoater 126′ can be caused to vibrate using a selected excitation device 126a′, which may be a sonotrode, ultrasonic transducer, or any other device suitable to cause the recoater 126′ to vibrate at the predetermined frequency. In some examples, the excitation device 126a′ can be a separate device positioned mechanically adjacent to the recoater 126′ to cause the recoater 126′ to vibrate as desired. In other examples, the excitation device 126′ can be integrated into the recoater 126′ to cause the recoater 126′ to vibrate as desired. Building a part 120′ using a more compacted, denser powder bed 106′ can result in a denser part 120′, which may be desirable for certain application. Also, a more compact, denser powder bed 106′ can potentially facilitate a PBF process in which the energy source 114′ with scanning system 115′ can scan the energy source 116′ over the top layer 118′ of the build powder bed 106′ at a faster rate than for a less compacted, less dense build powder bed (e.g., like a build powder bed 106 deposited using the prior art method described in the context of FIG. 1). In some examples, the faster scan rate can be used because the build powder bed 106′ is more compacted, in a denser state, and requires less external energy input from the energy source 116′ for consolidation. By improving the powder bed 106′ absorptivity of the energy provided by the energy source 116′ and allowing a faster energy source 116′ travel speed, this increases the powder consolidation rate (often called build rate).

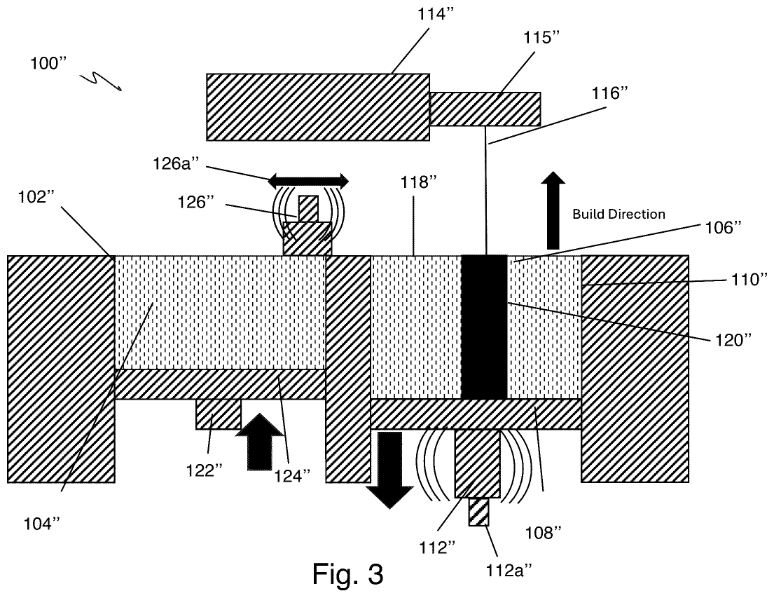

FIG. 3 shows another example of a PBF AM system 100″ of this disclosure that further improves the flowability of the fresh build powder 104″ by causing both the recoater 126″ and the build piston 112″ to vibrate with predetermined frequencies. Causing the build piston 112″ to vibrate also causes the connected build plate 108″ and build powder bed 106″ to vibrate. Alternately, the build plate 108″ can be caused to vibrate at the predetermined frequency directly, which then causes the build powder bed 106″ and build piston 112″ to vibrate. As with the example of FIG. 2, the predetermined vibrational frequencies can be any frequency suitable to cause the fresh build powder 104″ to pack into a more compacted, denser build powder bed 106″ as the recoater 126″ distributes fresh build powder 104″ over the build chamber 110″ and the build piston 112″ vibrates the connected build plate 108″ and build powder bed 106″. For example, the predetermined frequency can be between 10 Hz to 70 kHz. The specific predetermined vibrational frequencies for the recoater 126″ and the build piston 112″ can be selected to be appropriate for each particular application and can be the same for both the recoater 126″ and the build piston 112″ or different for the recoater 126″ and the build piston 112″. Similar to the example of FIG. 2, the recoater 126′ and build piston 112″ can be caused to vibrate using a selected excitation device 126a″, 112a″, which may be a sonotrode, ultrasonic transducer, or any other device suitable to cause the recoater 126′ and build piston 112″ to vibrate at the predetermined frequency. In some examples, the excitation device 126a″, 112a″ can be separate devices positioned mechanically adjacent to the recoater 126″ and build piston 112″ (or alternately the build plate 108″), respectively, to cause the recoater 126″ and build piston 112″ (or alternately the build plate 108″) to vibrate as desired. In other examples, the excitation device 126″, 112a″ can be integrated into the recoater 126″ and build piston 112″ (or alternately the build plate 108″), respectively, to cause the recoater 126″ and build piston 112″ (or alternately the build plate 108″) to vibrate as desired. Vibrating both the recoater 126″ and build piston 112″ (or alternately the build plate 108″) will result in a yet more compacted, denser build powder bed 106″ can result in a yet faster energy source 116″ scan rate over the top layer 118″ of the build powder bed 106″.

FIG. 4 shows another example of a PBF AM system 400 of this disclosure that similarly improves the flowability of the fresh build powder 404 by causing one or both of a fresh build powder distributor 426 and the build piston 412 to vibrate with predetermined frequencies. Causing the build piston 412 to vibrate causes the connected build plate 408 and build powder bed 406 to vibrate. In the example of FIG. 4, fresh build powder 404 is distributed from a fresh build powder distributor 426 that moves across the build powder bed 406 rather than with a recoater as in the examples of FIGS. 1-3. In the example of FIG. 4, the use of a fresh build powder distributor 426 to distribute fresh build powder 404 can eliminate the need for a fresh build powder reservoir. As with the examples of FIGS. 2 and 3, the predetermined vibrational frequencies for the fresh build powder distributor 426 and the build plate 408 can be between 10 Hz to 70 kHz. The specific predetermined vibrational frequencies for the fresh build powder distributor 426 and the build plate 408 can be selected to be appropriate for each particular application and can be the same both the fresh build powder distributor 426 and the build plate 408 or different for the fresh build powder distributor 426 and the build plate 408. In some examples, the predetermined vibrational frequency and fresh build powder distributor path over the build powder bed are selected to cause the layer of fresh build powder distributed over the build powder bed to be level and smooth.

Similar to the example of FIGS. 2 and 3, the fresh build powder distributor 426 and the build plate 408 can be caused to vibrate using a selected excitation device 426a, 408a, which may be a sonotrode, ultrasonic transducer, or any other device suitable to cause the fresh build powder distributor 426 and the build plate 408 to vibrate at the predetermined frequency. In some examples, the excitation device 426a, 408a can be separate devices positioned mechanically adjacent to the fresh build powder distributor 426 and the build plate 408, respectively, to cause the fresh build powder distributor 426 and the build plate 408 to vibrate as desired. In other examples, the excitation device 426a, 408a can be integrated into the fresh build powder distributor 426 and the build plate 408, respectively, to cause the fresh build powder distributor 426 and the build plate 408 to vibrate as desired. Vibrating one or both of the fresh build powder distributor 426 and the build plate 408 will result in a more compacted, denser build powder bed 406 can result in a faster energy source 416 scan rate over the top layer 418 of the build powder bed 406.

Vibrating the recoater 126′, 126″, fresh build powder distributor 426 and/or build piston 112″, 412 (alternately the build plate 108″, 408) at a predetermined frequency as discussed above, results in improved build powder flowability compared with prior art approaches. The resulting PBF process can be faster to build/consolidate build powder due to build powder grains becoming more compact.

### DISCUSSION OF POSSIBLE EMBODIMENTS

The following are non-exclusive descriptions of possible embodiments of the present invention.

A powder bed fusion (PBF) additive manufacturing (AM) system includes a build powder bed positioned on a build plate in a build chamber, an energy source scanning system configured to scan an energy source across a top layer of the build powder bed to consolidate selected portions of the top layer to build a single layer of a desired part, a build piston configured to adjust the height of the build plate and the build powder bed after the layer of the desired part is built, and a fresh build powder distributor configured to distribute a layer fresh build powder over a build powder bed such that the layer of fresh build powder is level and smooth. The fresh build powder distributor comprises a distributor excitation device configured to cause the fresh build powder distributor to vibrate at a predetermined vibrational frequency while distributing the layer of fresh build powder over the build powder bed.

The component protection casing of the preceding paragraph can optionally include, additionally and/or alternatively, any one or more of the following features, configurations and/or additional elements:

The distributor excitation device is positioned mechanically adjacent to the fresh build powder distributor.

The predetermined vibrational frequency and fresh build powder distributor path over the build powder bed are selected to cause the layer of fresh build powder distributed over the build powder bed to be level and smooth.

The build piston comprises a piston excitation device configured to cause the build piston to vibrate at a predetermined vibrational frequency while the PBF AM system is in operation.

The piston excitation device is positioned mechanically adjacent to the fresh build powder distributor.

The predetermined vibrational frequency of the fresh build powder distributor and the predetermined vibrational frequency of the build piston are both between 10 Hz and 70 kHz.

Further comprising: a fresh build powder reservoir, wherein the fresh build powder distributor is a recoater.

The distributor excitation device is positioned mechanically adjacent to the recoater.

The distributor excitation device is integrated into the recoater.

The build piston comprises a piston excitation device configured to cause the build piston to vibrate at a predetermined vibrational frequency while the PBF AM system is in operation.

The piston excitation device is positioned mechanically adjacent to the build piston.

The piston excitation device is integrated into the build piston.

The predetermined vibrational frequency of the resh build powder distributor and the predetermined vibrational frequency of the build piston are between 10 Hz and 70 kHz.

A method of making a part on a PBF AM system includes distributing, with a fresh build powder distributor, a layer fresh build powder over a build powder bed such that the layer of fresh build powder is level and smooth; causing, with a distributor excitation device, the fresh build powder distributor to vibrate at a predetermined vibrational frequency while distributing the layer of fresh build powder over the build powder bed, wherein the distributor excitation device is in mechanical contact with the fresh build powder distributor; scanning, with an energy source scanning system, an energy source across a top layer of the build powder bed to consolidate selected portions of the top layer to build a single layer of a desired part; and adjusting, with a build piston, the height of the build plate and the build powder bed after the layer of the desired part is built.

The method of the preceding paragraph can optionally include, additionally and/or alternatively, any one or more of the following features, configurations and/or additional elements:

The predetermined vibrational frequency and fresh build powder distributor path over the build powder bed are selected to cause the layer of fresh build powder distributed over the build powder bed to level and smooth.

Further comprising vibrating, with a piston excitation device, the build piston at a predetermined vibrational frequency.

The predetermined vibrational frequency of the fresh build powder distributor and the predetermined vibrational frequency of the build piston are both between 10 Hz and 70 kHz.

The fresh build powder distributor is a recoater.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A powder bed fusion (PBF) additive manufacturing (AM) system comprising:
a build powder bed positioned on a build plate in a build chamber;
an energy source scanning system configured to scan an energy source across a top layer of the build powder bed to consolidate selected portions of the top layer to build a single layer of a desired part;
a build piston configured to adjust the height of the build plate and the build powder bed after the layer of the desired part is built; and
a fresh build powder distributor configured to distribute a layer fresh build powder over a build powder bed such that the layer of fresh build powder is level and smooth;
wherein the fresh build powder distributor comprises a distributor excitation device configured to cause the fresh build powder distributor to vibrate at a predetermined vibrational frequency while distributing the layer of fresh build powder over the build powder bed.

2. The PBF AM system of claim 1, wherein the distributor excitation device is positioned mechanically adjacent to the fresh build powder distributor.

3. The PBF AM system of claim 1, wherein the predetermined vibrational frequency and fresh build powder distributor path over the build powder bed are selected to cause the layer of fresh build powder distributed over the build powder bed to be level and smooth.

4. The PBF AM system of claim 1, wherein the build piston comprises a piston excitation device configured to cause the build piston to vibrate at a predetermined vibrational frequency while the PBF AM system is in operation.

5. The PBF AM system of claim 4, wherein the piston excitation device is positioned mechanically adjacent to the fresh build powder distributor.

6. The PBF AM system of claim 4, wherein the predetermined vibrational frequency of the fresh build powder distributor and the predetermined vibrational frequency of the build piston are both between 10 Hz and 70 kHz.

7. The PBF AM system of claim 1, further comprising:
a fresh build powder reservoir, wherein the fresh build powder distributor is a recoater.

8. The PBF AM system of claim 7, wherein the distributor excitation device is positioned mechanically adjacent to the recoater.

9. The PBF AM system of claim 7, wherein the distributor excitation device is integrated into the recoater.

10. The PBF AM system of claim 7, wherein the build piston comprises a piston excitation device configured to cause the build piston to vibrate at a predetermined vibrational frequency while the PBF AM system is in operation.

11. The PBF AM system of claim 10, wherein the piston excitation device is positioned mechanically adjacent to the build piston.

12. The PBF AM system of claim 10, wherein the piston excitation device is integrated into the build piston.

13. The PBF AM system of claim 10, wherein the predetermined vibrational frequency of the resh build powder distributor and the predetermined vibrational frequency of the build piston are between 10 Hz and 70 kHz.

14. A method of making a part on a powder bed fusion (PBF) additive manufacturing (AM) system comprising:
scanning, with an energy source scanning system, an energy source across a top layer of the build powder bed to consolidate selected portions of the top layer to build a single layer of a desired part;
adjusting, with a build piston, the height of the build plate and the build powder bed after the layer of the desired part is built;
distributing, with a fresh build powder distributor, a layer fresh build powder over a build powder bed such that the layer of fresh build powder is level and smooth; and
vibrating, with a distributor excitation device, the fresh build powder distributor to vibrate at a predetermined vibrational frequency while distributing the layer of fresh build powder over the build powder bed.

15. The method of claim 14, wherein the predetermined vibrational frequency and fresh build powder distributor path over the build powder bed are selected to cause the layer of fresh build powder distributed over the build powder bed to level and smooth.

16. The method of claim 14, further comprising:
vibrating, with a piston excitation device, the build piston at a predetermined vibrational frequency.

17. The method of casing 16, wherein the predetermined vibrational frequency of the fresh build powder distributor and the predetermined vibrational frequency of the build piston are both between 10 Hz and 70 kHz.

18. The method of claim 14, wherein the fresh build powder distributor is a recoater.
